(19) United States
(12) Patent Application Publication
(10) Pub. No.: US 2009/0152833 A1
(43) Pub. Date: Jun. 18, 2009

(54) IMITATION POLICE VEHICLE

(76) Inventor: Lowell Frederick Johnson, Sedona, AZ (US)

Correspondence Address: Lowell Johnson, 4548 North Highway 89A, Sedona, AZ, 86336, US

(21) Appl. No.: 11/956,154

(22) Filed: Dec. 13, 2007

(51) Int. Cl. B60P 3/06; B60D 1/54; B29C 33/42

(52) U.S. Cl. 280/504; 280/400; 264/219

(57) ABSTRACT

A device and method of use as an imitation police passenger vehicle are disclosed. The imitation police passenger vehicle may have a molded shell in the shape of a police passenger vehicle which is placed on a trailer with four wheels with the wheels in positions similar to a police passenger vehicle. The imitation police passenger vehicle may be used to increase safety and deter crime.

### BACKGROUND

The invention relates to security systems and to devices for deterring crime and illegal activity. The invention also relates to traffic control devices.

There are many areas where police presence is a deterrent to crime and illegal activity, and where the presence of police increases safety. One area is on the roads. Some roads have higher rates of speeding, and corresponding vehicle crashes. Studies have been performed which confirm that the presence of a police officer, or even a police passenger vehicle will reduce the number of people speeding. There is a limitation, however, of police resources and the places where police may be at any one time to deter speeding and other crime.

To address this limitation some police departments have placed an unoccupied police passenger vehicle near a roadway or other area where crime prevention is desired. Having a police passenger vehicle which is clearly unoccupied may have a limited effect on deterring illegal an unsafe activity such a speeding. This problem has been addressed with dummies which have been set up in police passenger vehicles to provide the appearance of the police passenger vehicle being occupied.

This technique also has limitations and problems. One limitation is the high cost of a police passenger vehicle, and the time required for dropping off and picking up the vehicle. With the high cost of the police passenger vehicle, and the time required to drop off a vehicle, this solution also has a high cost, and the risk of someone stealing the police passenger vehicle when not attended.

One solution which has addressed the high cost of using real police cars with dummies is using signs which appear like a police passenger vehicle. The signs are cut-outs generally in the shape of a vehicle, or a sign painted to look like a police passenger vehicle next to a road. These signs are then placed next to the road so that from a certain vantage point the sign may remind people who view the sign from that vantage point of a police vehicle. Although this is a low cost alternative to placing a police vehicle with a dummy, there are limitations to this method.

One problem with police vehicle cut-outs is that they only work from one or possibly two vantage points. As these are designed primarily for people who are moving, the effect of crime deterrent is only temporary because the sign is quickly identified as an imitation.

The disclosed device and methods overcome at least some of the disadvantages of prior devices and methods.

### SUMMARY

The devices and methods disclosed may include using a full size molded shell in the shape of a police passenger vehicle which sits on a trailer frame. The trailer frame wheels may be functional and add to the realistic effect of the presence of a police vehicle.

Various embodiments of an imitation police passenger vehicle may be produced and used. One embodiment may include an imitation police passenger vehicle with a trailer frame having a trailer tongue, the trailer frame may have a first set of wheels, and a second set of wheels. The imitation police passenger vehicle may have a molded shell being formed from moldable material in the shape of a vehicle, the molded shell may have a front, a rear, a top, and sides with wheel wells. The front of the molded shell may have a windshield area which is formed of the moldable material in the shape of a windshield. The windshield area may be formed as part of the molded shell, the molded shell may have side window areas which are formed of the moldable material in the shape of side windows and may be formed as part of the molded shell. The molded shell may have a rear window area which is formed of the moldable material in the shape of a rear window, the rear window area being formed as part of the molded shell.

The imitation police passenger vehicle may also have a molded shell which may be mounted on the trailer frame so that the location of the first set of wheels and the second set of wheels corresponds with the wheel wells.

The imitation police passenger vehicle may also have a molded shell which may be colored and detailed to appear like a police passenger vehicle. An image made to appear like the window of an occupied police passenger vehicle may be placed on one or more of the windows of the imitation police passenger vehicle.

The imitation police passenger vehicle may include an emergency vehicle light mounted on the top of the molded shell.

An imitation police passenger vehicle may also include a power supply and an electrical connection between the emergency vehicle light and the power supply so that the emergency vehicle light is operational. The power supply may be a battery which is charged by a solar panel, and the solar panel may be mounted on the molded shell. Batteries may also be charged by an outside power source such as household power or “shorepower”.

An imitation police passenger vehicle may also include a security camera dome which is mounted on the molded shell.

An imitation police passenger vehicle may also include a trailer tongue which may be retractable or removable to hide the trailer tongue from the view of an observer.

An imitation police passenger vehicle may also include a first set of wheels and a second set of wheels which are operational as wheels of the trailer.

A method of making a vehicle which appears like a police passenger vehicle may include producing a trailer having a frame with four wheels, where at least two of the wheels are functional wheels. A front set of wheels may be approximately in the position of the front wheels of a vehicle, and a back set of wheels may be approximately in the position of the back wheels of a vehicle.

The method of making a vehicle which appears like a police passenger vehicle may also include producing a mold in the shape of the vehicle including the windows of the vehicle. Which step may be followed by producing a shell in the shape of the vehicle using the mold in the shape of the vehicle. The shell in the shape of the vehicle may include solid areas corresponding to windows on the vehicle.

The shell may be attached to the trailer so that the wheels on the trailer appear in a similar position as they appear on the vehicle. The vehicle may be detailed to appear as a police passenger vehicle. An emergency light strip may be attached to the police passenger vehicle.

A method of increasing police presence visibility may include producing a trailer having a frame with 4 wheels, where at least two of the wheels may be functional wheels. A front set of wheels may be approximately in the position of the front wheels of a vehicle, and a back set of wheels may be approximately in the position of the back wheels of a vehicle.

A mold may be produced in the shape of the vehicle including the windows of the vehicle. A shell may be produced in the shape of the vehicle using the mold in the shape of the vehicle. The shell in the shape of the vehicle may include solid areas corresponding to windows on the vehicle.

The shell may be attached to the trailer so that the wheels on the trailer appear in a similar position as they appear on the vehicle. The shell may be detailed to appear as a police passenger vehicle. An image may be placed on the shell on the solid areas corresponding to the windows. The image may create the appearance of a police officer inside of the shell. An emergency light strip may be attached to the police passenger vehicle.

The trailer with the shell may be placed in an area where increased police visibility is desired.

Advantages over prior solutions to safety and security issues may be realized in at least some of the embodiments of the invention. One advantage which may be achieved in at least some embodiments of the invention is reduced negative impact on the environment. In many cases police passenger vehicles are currently used to increase safety on roadways and especially in construction zones where workers are present beside roadways. Police passenger vehicles are many times parked with lights on and the engine running. In one embodiment of the invention an imitation police passenger vehicle may serve the same function and may have working lights which are run from batteries or another power source which would use have little or no emissions compared to an idling vehicle. The power source may be batteries which are charged from solar panels.

Another way in which an embodiment of the invention may reduce the harm to the environment is through the reduction of unnecessary vehicle production. When police vehicles are produced they are produced with some parts which are not recycled, and with some parts which cannot be recycled easily. The imitation police passenger vehicle may be produced with parts which may be recycled easily and with minimal or no parts which are difficult to recycle.

### BRIEF DESCRIPTION OF THE DRAWINGS

FIG. 1 shows a perspective of an embodiment of the invention

FIG. 2 shows a top view of a trailer according to an embodiment of the invention.

FIG. 3 shows a top view of a trailer according to an embodiment of the invention.

FIG. 4 shows side view of a trailer according to an embodiment of the invention.

FIG. 5 shows a top view of a trailer according to an embodiment of the invention.

FIG. 6 shows a perspective view from the rear of an embodiment of the invention.

FIG. 7 shows a perspective view from the front of an embodiment of the invention.

FIG. 8 shows an image graphic for use on a windshield according to an embodiment of the invention.

FIG. 9 shows a diagram of connections between optional systems in an example embodiment of the invention.

FIG. 10 shows a side view of a molded shell attached to a frame in an open position according to an embodiment of the invention.

FIG. 11 shows a diagram of example steps in an example method according an embodiment of the invention.

### DETAILED DESCRIPTION

Example embodiments of the invention are shown in the drawings. A method of making and using an imitation police passenger vehicle may be performed as described and may create a realistic looking imitation police passenger vehicle which may be used by for increased security and safety.

For the purposes of this patent application the term “police passenger vehicle” means a marked vehicle which is used for security purposes to patrol or police an area. A “police passenger vehicle” may be a private security vehicle, or may be a vehicle used by a public safety officer, or police officer, or may be a marked vehicle used by other security personnel, such as border patrol. A police passenger vehicle may be any type of vehicle used to transport police including but not limited to: four door vehicles, two door vehicles, sport utility vehicles, vans, sports coups, armored vehicles, armored vans, off road vehicles, busses, station wagons, trucks and electric vehicles.

The figures show examples of an imitation police passenger vehicle 1 with a molded shell 10 in the shape of a passenger police vehicle body. In the example embodiments the molded shell 10 has a front 11, a rear 13, a top 15, and sides 17. The front 11 may include a windshield area 12. The rear 13 may include a rear window area 14. The molded shell may have a top 15, and an emergency vehicle light or emergency light strip 16 may be mounted on the top 15 of the molded shell 10. The molded shell may have sides 17 with the shape of wheel wells 18. The sides 17 may have side window areas 19. A molded shell may be made from materials such as, but not limited to fiberglass, plastics, metal, and resins. The molded shell may be made in one or more pieces. The emergency vehicle light 16 may be a single light in a dome, or it may be a light bar, or other emergency vehicle light configuration which is similar to an emergency light on a marked police passenger vehicle.

A trailer 20 may be used with an example imitation police passenger vehicle as shown in the drawings. The trailer frame 20 may have a trailer tongue 21, which may be removable or retractable. The trailer tongue 21 may be inserted into a trailer tongue insert 70, and removed from the trailer tongue insert 70 when not in use. The trailer may have a first set of wheels 22. The first set of wheels 22 may be wheels on the front (or nearest to the trailer tongue) of the trailer frame 20 which are function wheels of the trailer, or they may be wheels which are not function but which are attached to the trailer 20. Functional wheels may be used when the trailer frame 20 is being towed. The first set of wheels may be functional, but not used when the trailer frame 20 is being towed but instead may be useful for positioning the vehicle after unhitching the vehicle. The first set of wheels 22 may be fixed as the rear axle of a vehicle which does not turn, or the first set of wheels 22 may be able to turn like the front wheels of a standard passenger vehicle.

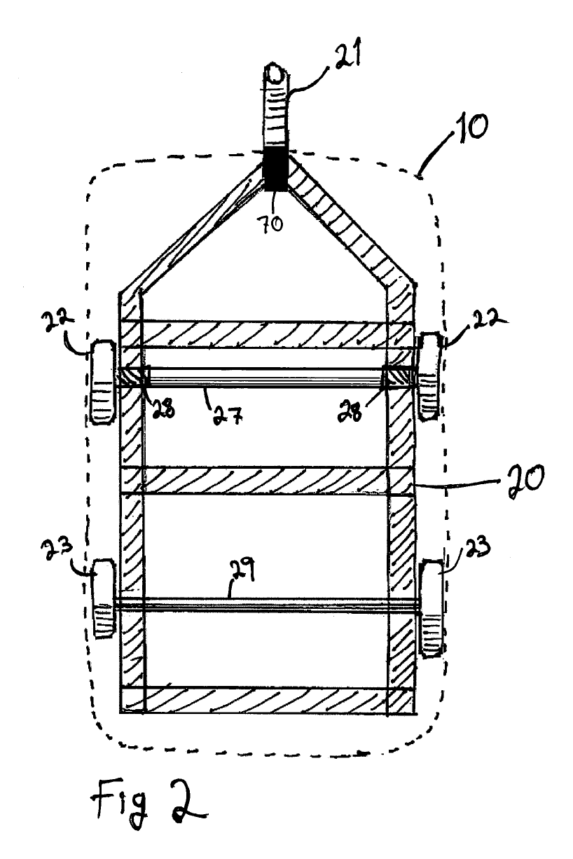

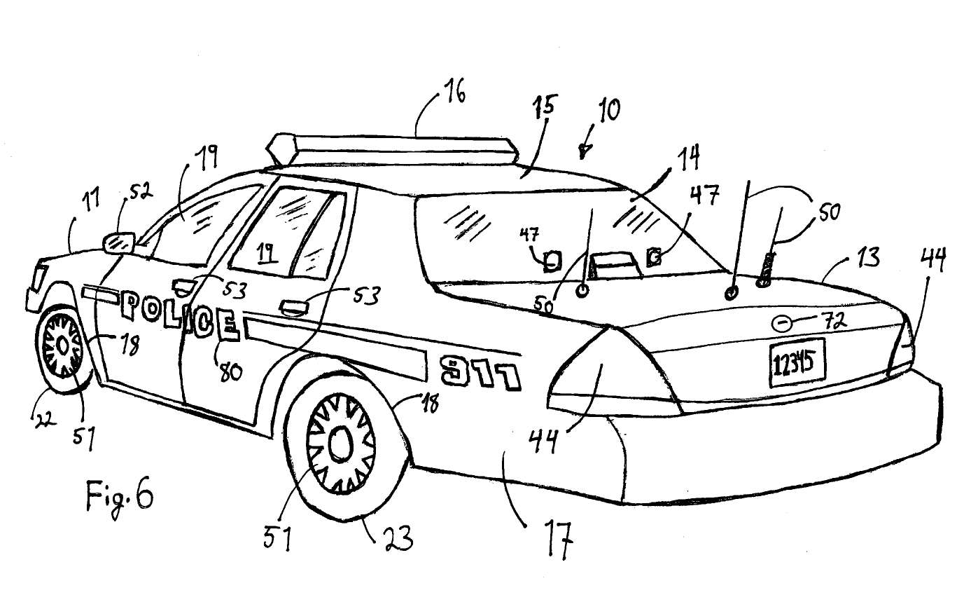

The trailer frame 20 may have a front axle 27 for the first set of wheels 22. If the first set of wheels are not functional it may be unnecessary to have a front axle 27, as the first set of wheels may be attached to the trailer frame without an axle. The trailer may also have a lift system for lifting the trailer when hitching and unhitching the trailer. One embodiment of a lift system may be a mechanical lift system 28, which may be situated between the front axle 27 and the trailer frame 20. The mechanical lift system 28 may be a hand operated system as shown in FIG. 5 with a hand crank 71, or it may be a motor driven or pneumatic lift system with one or more motors as shown in FIG. 2. The mechanical lift system 28 may lift the front of the trailer frame 20 for unhitching from a vehicle, or for preparing to hitch the trailer frame 20 to a vehicle. The mechanical lift system 20 may also be used to lower the trailer frame 20 onto the hitch of a towing vehicle. When the trailer frame 20 is hitched to a towing vehicle, the mechanical lift system 28 may be used to lift the first set of wheels 22 off of the ground. The mechanical lift system 28 may also be used to level the trailer frame 28 on uneven ground when the trailer is not being towed. As an alternative mechanical lift system 28 a standard trailer tongue lift jack may be used, which may be attached to the trailer tongue 21 or to the trailer tongue insert 70 or may be attached to another part of the trailer frame 20.

The trailer frame 20 may have a second set of wheels 23 attached to a rear axle 29. The second set of wheels 23 may be used to support the trailer frame 20, and may be used as the wheels of the trailer frame 20 for when the trailer frame 20 is being towed.

The trailer frame 20 may have a front axle loop 26 and rear axle loop 69. The front axle loop and the rear axle loop may be used to support the axles of the trailer frame 20. The front axle loop 26 may have a large enough area to accommodate an embodiment of the mechanical lift system 28, and may allow the first set of wheels 22 to be retracted off of the ground when the trailer frame 20 is hitched to a towing vehicle.

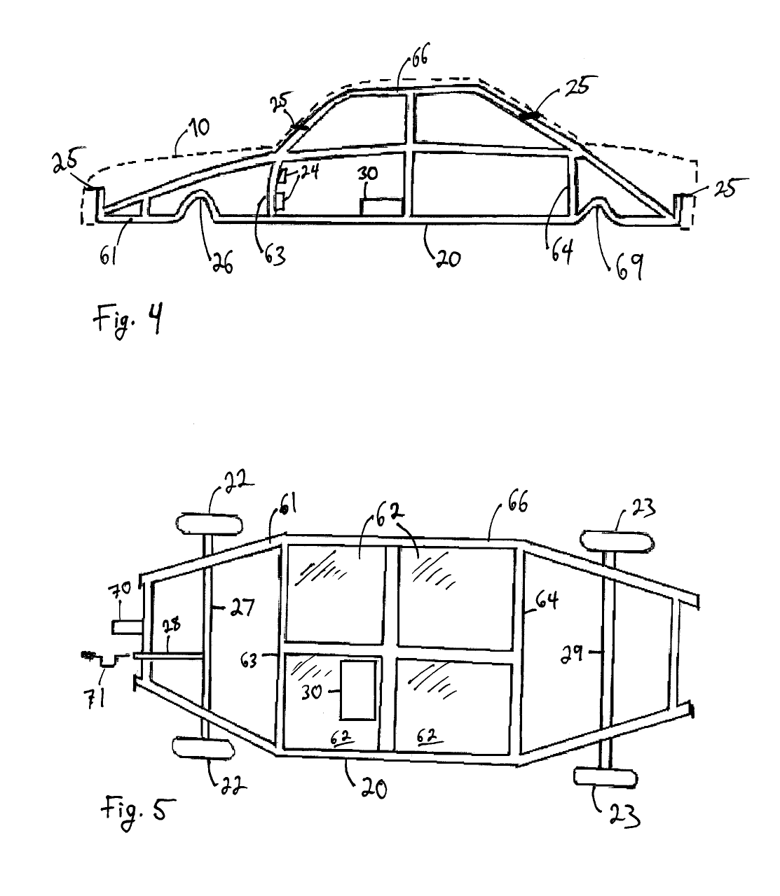

The trailer frame 20 may have mounts 25 for mounting a full size molded shell 10 which is in the shape of a police passenger vehicle body. The trailer frame 20 may include metal tubing 61 similar to the metal tubing used for the chassis for recreational vehicles and some racing vehicles. Alternatively, the trailer frame 20 may be similar to a standard flatbed trailer. In one embodiment of a trailer frame 20 shown in FIGS. 4 and 5, a trailer frame may be made from metal tubing 61, and may have a frame to support a molded shell 10 in the shape of a vehicle. The example frame may have a sheet metal for a floor pan 62 and for a front panel 63 and for a rear panel 64. The front panel 63, rear panel 64 and floor pan 62 sections, together with the molded shell 10 may make an area inside of the imitation police passenger vehicle. The area inside of the imitation police passenger vehicle may be used for equipment, and may have an opening. Supports for an opening 24 may be attached to the metal tubing or other part of the trailer frame 20. The area inside of the imitation police passenger vehicle may be sealed using various methods, including sealing with caulking, and sealing by welding, or with other known methods of sealing an area. It may be advantageous to have an area inside of the imitation police passenger vehicle which is or which will have minimal exposure to dirt and water. The area inside of the imitation police passenger vehicle may include a control box 30.

An example frame 20 may have a top rail 66 to assist in supporting the molded shell 10. Alternatively the molded shell 10 may be produced to have enough support so that no separate support frame is needed other than a manner of attaching the molded shell 10 to the trailer frame 20.

The first set of wheels 22 and the second set of wheels 23 may be the same size as the wheels on a passenger vehicle used by police officers, and may have the hubcaps and wheel center caps 51 which look similar to or the same as hubcaps and wheel center caps used on a passenger vehicle used by police officers. This may add to the realistic effect of an imitation police passenger vehicle. The first set of wheels 22 and the second set of wheels 23 may be attached to the trailer frame 20 in positions which correspond to the position of wheels on a passenger vehicle used by police officers.

For example police department X may have many police passenger vehicles which are a 2006 Brand Z police passenger vehicle, and would like to have additional imitation police passenger vehicles. The 2006 Brand Z may have a front axle with wheels and a rear axle with wheels which are in a standard position relative to the body of the 2006 Brand Z. The wheels and tires of police Department X's 2006 Brand Z police passenger vehicles may be of a standard size, and may have a standard hubcaps and wheel center caps which are used. A trailer may be assembled for use by police department X with a molded shell in the shape of a 2006 Brand Z. The trailer may have a first set of wheels 22 and a second set of wheels 23 which are of the same size and which use the same tires as Department X's 2006 Brand Z police passenger vehicles. The trailer wheels may also have hubcaps which are the same hubcaps which are used on Department X's 2006 Brand Z police passenger vehicles. Having the same wheels, tires and hubcaps on both the active functional police passenger vehicles and the imitation police passenger vehicles may add to the realistic effect of a police passenger vehicle created by the imitation police passenger vehicle.

The molded shell 10 may be produced by making a mold in the shape of a vehicle body. The mold may include parts of the vehicle such as for example: headlights 43, tail lights 44, door handles 53, grills 41, side mirrors 52, and an emergency vehicle light or emergency light strip 16. Alternatively the mold may be made without parts of the vehicle for example: headlights, tail lights, door handles, grills, side mirrors, and an emergency vehicle light or emergency light strip. If the mold is made without the parts, then parts may be obtained and installed on the molded shell 10 after a shell is made from the mold.

For example the headlights 43 may be part of the mold and the molded shell may have molded material in the shape of headlights 10. The molded shell 10 may then be decorated with paint or stickers or other markings which will appear like the headlights of a police passenger vehicle. In this example an imitation police passenger vehicle may be produced at a relatively low cost with just a shell which is colored, decorated and detailed to appear as a police passenger vehicle, with the shell mounted on a trailer frame with wheels.

Alternatively the mold may be produced without the headlights, and the molded shell may be formed without the headlights. Headlights may then be installed on the molded shell 10 using actual headlight replacement parts. The headlights on the imitation police passenger vehicle may then be made as operational in a manner similar to the headlights of an active functional police passenger vehicle.

A front grill 41 may also be made as part the molded shell, or may be installed after the molded shell is formed. A front grill 41 may be a grill with front grill siren lights 48 and an emblem 42. The front grill siren lights 48 may function. Alternatively, the front grill 41 may have non-functional lights or may be installed without lights, but may still serve to enhance the realistic effect of the presence of a police passenger vehicle.

An example imitation police passenger vehicle may have additional options to enhance the effect of providing security and safety. A security camera dome 49 may be placed on the imitation police passenger vehicle. The security camera dome 49 may have a camera in it, or it may be placed on the imitation police passenger vehicle to give the appearance of a camera. This may be useful if an imitation police passenger vehicle was used regularly in an area such as a school or a shopping mall where individuals upon close inspection may be able to discover that the imitation police passenger vehicle is a security device and not an actual police passenger vehicle. In these situations the imitation police passenger vehicle may have a security camera dome 49 to deter criminal activity, whether or not a camera is placed in the security camera dome 49.

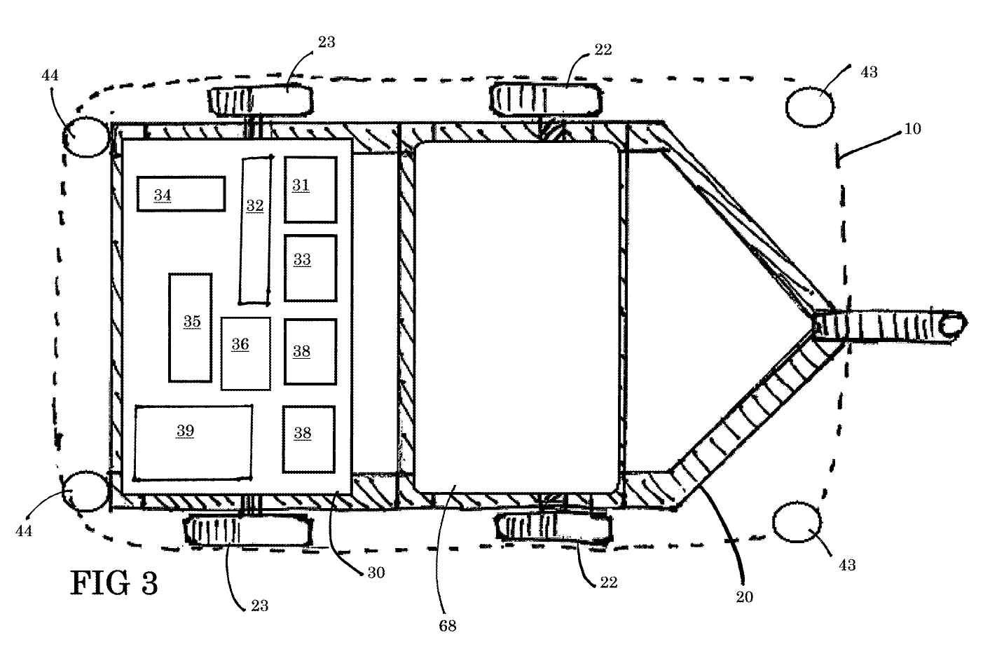

An example imitation police passenger vehicle may have an additional option of a control box 30 with optional controls and equipment. Optional equipment may include but is not limited to: radar equipment 31, light controls 32, a car alarm system 33, a communication system 34, a computer with software controls 35, a power supply 36, solar panels 37, batteries 38, and a generator 39. Many of the controls and optional equipment may be housed inside a control box 30 as shown in FIG. 3. Equipment may also be housed in other parts of imitation police passenger vehicle 1.

Access to the control box 30 may be through a hatch or panel. For example an access panel may be in a place where a passenger door would normally be, or may be part of a door or panel. In FIG. 4 supports for an opening 24 are shown so that the area below the driver's side window may open as a hatch and provide access to equipment inside of the imitation police passenger vehicle. A door handle 53 may function to open the hatch or door. In another example the area which corresponds to the trunk of a police passenger vehicle may be used as a hatch, and a key may be required to open the hatch using a key hole 72 in a manner similar to using a key to open the trunk of a police passenger vehicle. A hatch or opening may be placed in other areas for access to a control panel or other equipment inside of the imitation police passenger vehicle.

Referring to FIG. 10 showing a side view of a molded shell attached to a frame in an open position according to an embodiment of the invention, access to a control panel 30 and other equipment inside of the molded shell 10 may be accomplished by attaching the molded shell with hinges 82 to the trailer frame 20. The molded shell 10 may move as a unit on hinges 82, and the molded shell 10 may be supported by supports 83 which may be gas filled struts or other supports. When closed the molded shell 10 may have a latch 84 at a position opposite the hinges 82, and may be secured to the trailer frame 20 with other latches or supports.

The option of including radar equipment 31 may increase the realistic effect of having police presence, especially when the imitation police passenger vehicle is used near a road way where passing cars would expect a radar signal to be present when the a police passenger vehicle is present. There are many devices for detecting the presence of radar which motorists use in their vehicles. For these motorists the presence of radar will enhance the realistic effect of having a police passenger vehicle present. Another option is to use the imitation police passenger vehicle with photo radar equipment to photograph the license plates and or images of speeding motorists. Police departments currently use police passenger vehicles with photo radar enforcement, and it may be useful to provide a lower cost option by providing an imitation police passenger vehicle to accomplish the same photo radar enforcement activity as an actual police passenger vehicle equipped with photo radar.

The light controls 32 may be used if the imitation police passenger vehicle is equipped with any working lights such as but not limited to: headlights 43, headlights 43 with strobe lights, tail lights 44, tail lights 44 with strobe lights, side marker lights 45, side marker lights 44 with strobe lights, front grill siren lights 48, rear window siren lights 47, emergency vehicle light 16 or emergency light strip 16. The working lights may be operated with light controls 32 which may be physical manual switches, or which may be controlled by a computer to switch the lights on and off. The lights may be programmed to come on only under certain conditions. For example lights may be programmed to only come on when a certain condition exists such as but not limited to: a light sensor indicating that it is dark, a speed detector indicating that a vehicle is traveling at a speed in excess of a set speed, or a motion detector detecting movement in the general area of the imitation police passenger vehicle. The lights may be programmed to only come on at specified times of a day and on specified days of the week, for example during normal rush hour traffic times, or during scheduled working times at a construction site.

Working lights may be Light Emitting Diodes or LEDs which may consume far less power than filament bulbs. Working lights may also be filament bulbs or gas bulbs or other light sources known in the art for emergency vehicle lights.

A car alarm system 33 may also be included as an option for an imitation police passenger vehicle. A car alarm system 33 may detect interference with the imitation police passenger vehicle and sound an audible alarm, or may remotely notify police or other security of an attempt to tamper with the imitation police passenger vehicle. A car alarm system 33 may incorporate any or all features which are known in the art of car alarm systems.

A communication system 34 may be included as an option for an imitation police passenger vehicle. A communication system 34 may use one or more of many different communication devices including, but not limited to: cell phone, satellite, GPS, radio frequency, or other wireless communication systems. The communication system may allow for wireless remote communication with other features on the vehicle. For example the imitation police passenger vehicle may have a camera in a security camera dome 49 which may transmit a live video stream which may be monitored or recorded. The camera may also be manipulated remotely with a mount that would allow for the camera to turn in different directions. Another example of the use of a communication system 34 with the imitation police passenger vehicle is in relation to a car alarm system 33 as discussed above. Another use of a communication system 34 is GPS tracking by receiving a GPS signal and transmitting the position of the vehicle to a remote location. Another example of the use of a communication system 34 is in connection with radar equipment 31 or other speed measurement device, or photo radar enforcement option to transmit images and the speed of vehicles traveling over the speed limit to a remote location. The communication system 34 may also remotely communicate the status of batteries 38 or power supplies 36 or fuel in a generator 39. The communication system 34 may also allow for remote programming of lights, or turning systems on or off.

A computer with software controls 35 may also be included as an option for an imitation police passenger vehicle. This may allow for changing of various options and settings using software control.

A display panel may also be optionally mounted on the shell 10, or mounted inside the imitation police passenger vehicle. The display panel may be operated remotely, and may be activated when an emergency message needs to be communicated. For example a display panel may be placed behind a tinted window of an embodiment of the imitation police passenger vehicle, or made to appear as a tinted window when not activated. When an emergency situation occurs such as a child being kidnapped, or a serious accident on the roadway, a remote signal may activate the panel through the communication system 34, or it may have a separate communication device. The remote signal may also send a communication message for displaying on the panel. A message on the display panel may be visible through the tinted window when the display panel is activated. The display panel may be deactivated remotely when the emergency situation has passed, and the display may be hidden again behind a window or other area of the imitation police passenger vehicle.

A power supply 36 may also be included as an option for an imitation police passenger vehicle. It may be advantageous to provide a power supply 36 which may accept input power from batteries 38, or from solar panels 37, or from a generator 39, and which can supply the proper voltage and current for a computer with software controls 35, and for lighting systems, and for communication systems 34 and for other options which may need power to operate. A power supply 36 may also be a connection to a household power source or shorepower, or may be a connection to an external generator or other power source.

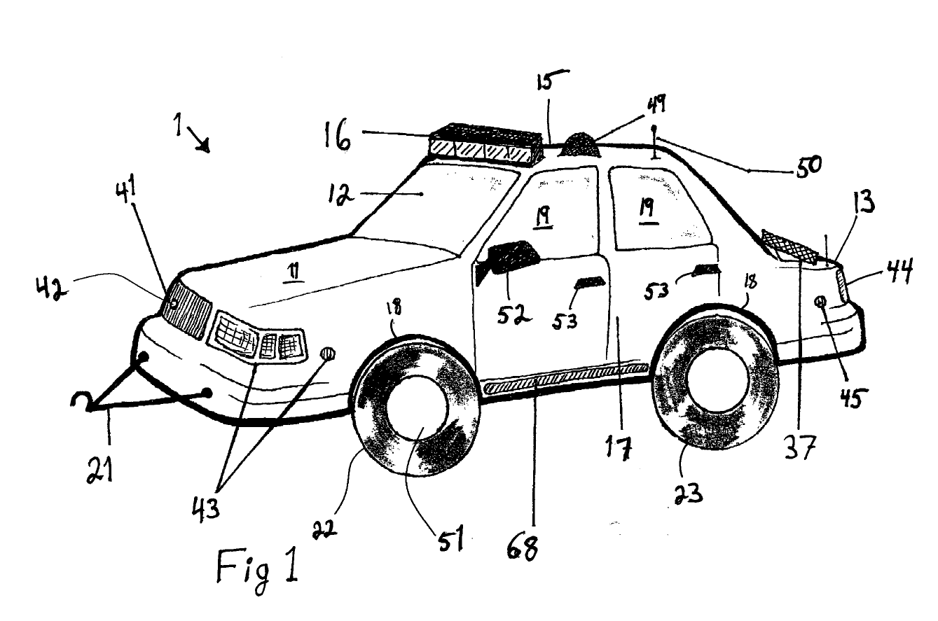

Solar panels 37 may also be included as an option. Solar panels 37 may be placed on the rear 13 of the imitation police passenger vehicle as shown in FIG. 1, or it may be placed on other parts of the imitation police passenger vehicle. Solar panels 37 may also be built into the imitation police passenger vehicle so that the surfaces of the vehicle may be solar panels 37. For example the surface of the rear 13 or trunk area may be solar panels 37, or the surface of the rear window area 14, or the front 11 or hood area may be a solar panel 37. Other areas or surfaces may include a solar panel 37 or may have a solar panel 37 placed on them. The solar panels 37 may provide power to charge batteries 38, and may also provide power directly to a power supply 36.

Batteries 38 may be used to power optional equipment on an imitation police passenger vehicle. One or more batteries 38 may be used and batteries of various shapes or sizes may be used including standard car batteries, or batteries which are designed specifically for operating computer equipment. Batteries may be charged from solar panels 37, or from a generator 39. Batteries may also be charged from regular household power or shorepower, using an inverter to change the AC current to a DC current. The power supply 36 may be an inverter which accepts power from household power or shorepower, or from an external generator or other power source.

A generator 39 may also be optionally included as part of an imitation police passenger vehicle. A generator 39 may operate continuously supplying power, or it may operate together with batteries 38 to charge batteries when needed. A generator 39 may also supply power which is external to the imitation police passenger vehicle, for example if an imitation police passenger vehicle was used at a construction site, power may be supplied to external devices which are typically used at a construction site. The generator 39 may be selected to meet the expected power needs and may be a small low capacity generator or a large high capacity generator. A generator may be advantageous where power from a solar panel is not sufficient to meet the power needs of optional lights and other equipment. If the size of the generator is selected correctly greenhouse gas emissions may be substantially reduced compared to an idling engine on an unmanned police passenger vehicle.

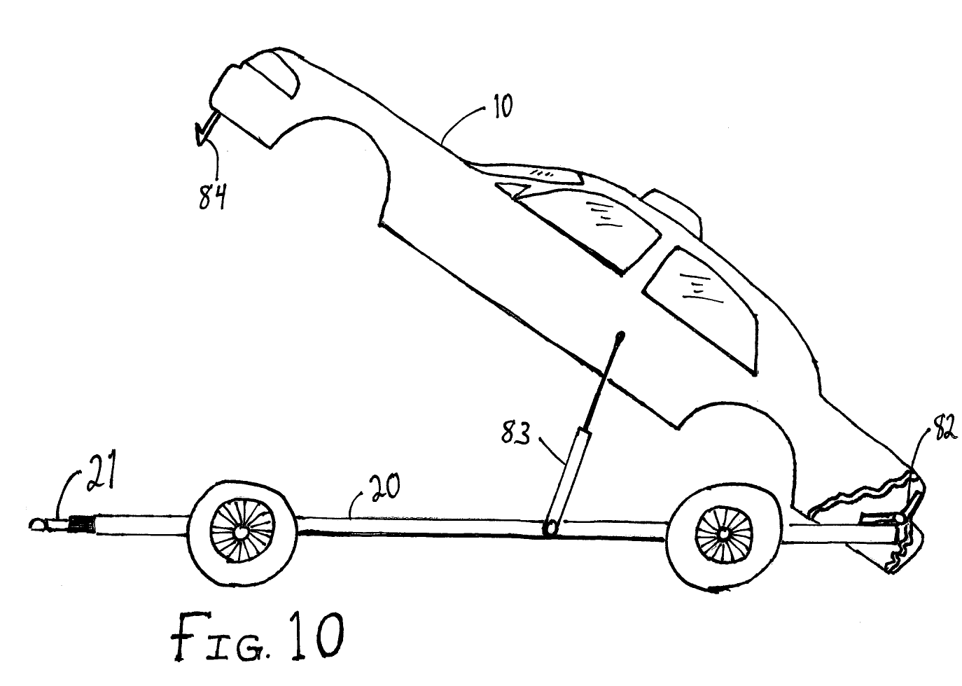

The optional features may be connected electrically by electrical connections 81 as shown by the example in FIG. 9. For example, sources of power may include a generator 39, and solar panels 37, which may be connected to batteries 38. The generator 39 and the solar panels 37 may also be connected to a power supply which regulates voltage and current for multiple devices. Batteries 38 may also be connected to a power supply for regulating voltages and current. The power supply 36 may be connected to a car alarm 33, and radar equipment 31, and may supply power to light controls 32. The light controls may supply power to lights 40, which may include headlights 43, tail lights 44, side marker lights 45, rear window siren lights 47, front grill siren lights 48, emergency light strip 16, and other lights which may be used with an imitation police passenger vehicle.

A computer 35 may also be used and may have electrical connections, or other communication systems to provide controls to other systems. For example a computer 35 may be connected to a communication system 34 and may be controlled remotely. The computer 35 may also be connected to radar equipment 31, and to a car alarm 33. The computer 35 may receive information, and send information to the radar equipment 31 and to the car alarm 33. This information may also be sent to the communication system and transmitted wirelessly. The computer 35 may also be connected to the light controls 32, and may operate the light controls 32. The light controls 32 may be operated remotely using the communication system 34 connected to the computer 34.

The trailer frame 20 may also include weights 68. Depending on the options installed in the imitation police passenger vehicle, the imitation police passenger vehicle may be relatively light which may reduce the costs of transporting and make it very easy to position the imitation police passenger vehicle as needed. The imitation police passenger vehicle may include weights 68 which may be placed in the center of the trailer frame 20 as shown in FIG. 3, or which may be placed in various locations throughout the imitation police passenger vehicle and on the trailer frame 20. Weights may assist in making the trailer more stable while towing, and may reduce the chance of the imitation police passenger vehicle being moved by high winds. Weights 68 may be in the form of a water bladder which may be filled and emptied as needed. Weights 68 may be in the form of sand bags or other weights.

An imitation police passenger vehicle may be colored or have detailing 80 similar to detailing on a police passenger vehicle. If an imitation police passenger vehicle is designed for a specific police department, then the name of the police department or city may be detailed on the vehicle in the same manner, or a similar manner as other police passenger vehicles are colored or detailed.

Antennas 50 may also be placed on an imitation police passenger vehicle as an option. The antennas 50 may be real antennas, and may function with equipment in the imitation police passenger vehicle. The antennas 50 may also be imitation antennas. The antennas 50 may be placed in a similar manner as antennas on a police passenger vehicle to enhance the realistic effect of the presence of a police passenger vehicle.

The imitation police passenger vehicle may have different options for the window areas including the windshield area 12, the rear window area 14 and the side window areas 19. The window areas may be made as part of the molded shell 10 as solid areas having a surface the same shape as corresponding areas on a vehicle used as a police passenger vehicle. The window areas may be colored to appear the same color as the windows of a police passenger vehicle, and may be colored with a black color to imitate tinted windows. The imitation police passenger vehicle may also include image graphics 54 or an image made to appear like the window of an occupied police vehicle 54 on any of the window areas 12, 14, 19. For example the windshield area 12 may include image graphics 54 which show the image of a person 73, and features from the interior of a vehicle such as, but not limited to images of headrests 74, image of car interior 75, images of a rear window 76, and images of side windows 77. The image graphics 54 may be produced by taking a picture of a police officer in a police passenger vehicle similar to the imitation police passenger vehicle, and producing an image graphic 54 which may be placed on the windshield area 12, or other window area of the imitation police passenger vehicle. The image graphic may be painted or printed directly onto the molded shell 10, or the image graphic 54 may be printed on vinyl or other material and secured to the molded shell 10 with adhesives. Other methods of placing an image on a vehicle which are know in the art of vehicle graphics may be used to place the image graphic 54 on a window area of the imitation police passenger vehicle.

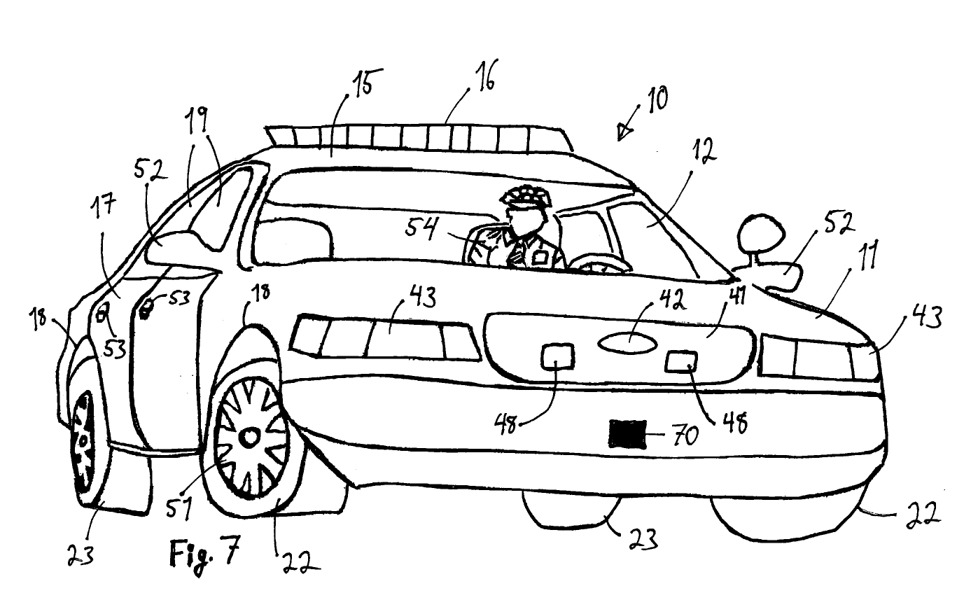

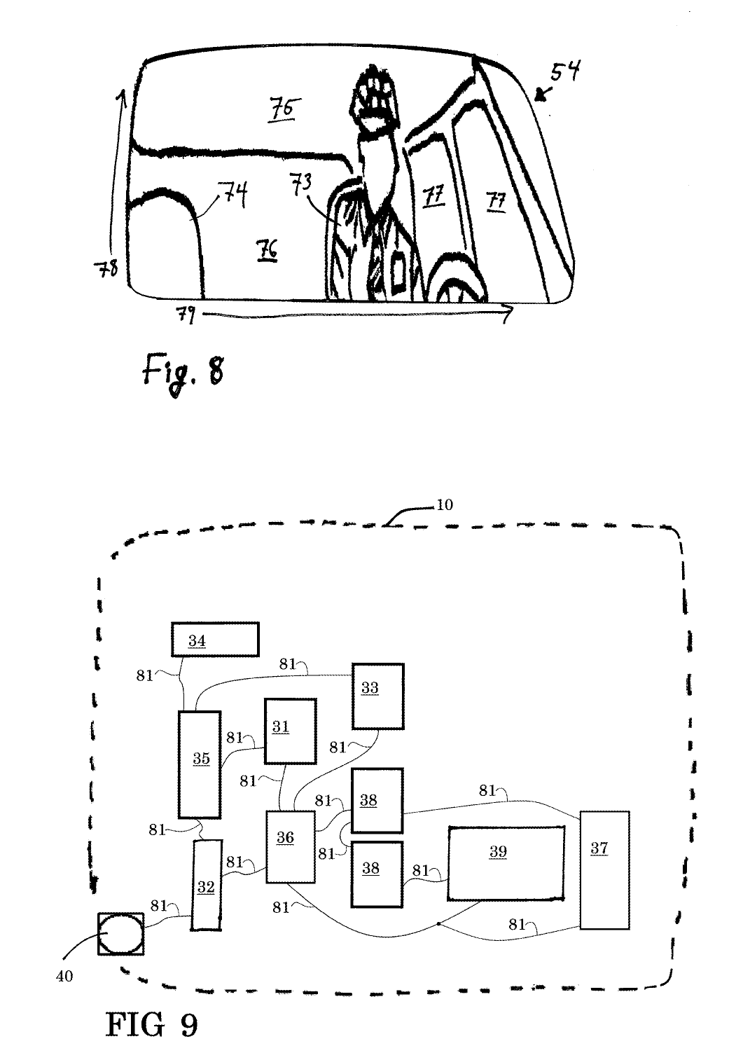

The image graphic 54 may be have distortions in a vertical direction 78 and may have distortions in a horizontal direction 79. This may be advantageous to make the image graphic 54 appear more realistic to a person observing the imitation police passenger vehicle, especially from a particular angle. Other methods of skewing or distorting the image graphic 54 including anamorphic effects and other effects performed by a computer may be used to adjust the picture when producing the image graphics 54. For purposes of illustrating this principal the image from FIG. 7 which is the image graphic 54 on the windshield area 12 has been distorted as shown in FIG. 8 and shaped into the shape of a vehicle windshield.

In an example embodiment the molded shell 10 may be produced with openings in at least one of the window areas including the windshield area 12, the rear window area 14, and the side window areas 19. The opening may have Plexiglas or other material to simulate glass in the window areas. The opening may also have vehicle window glass installed in the opening. The simulated or real glass may be tinted so that it is difficult to see through the window, and may give the appearance of tinted windows on a police passenger vehicle.

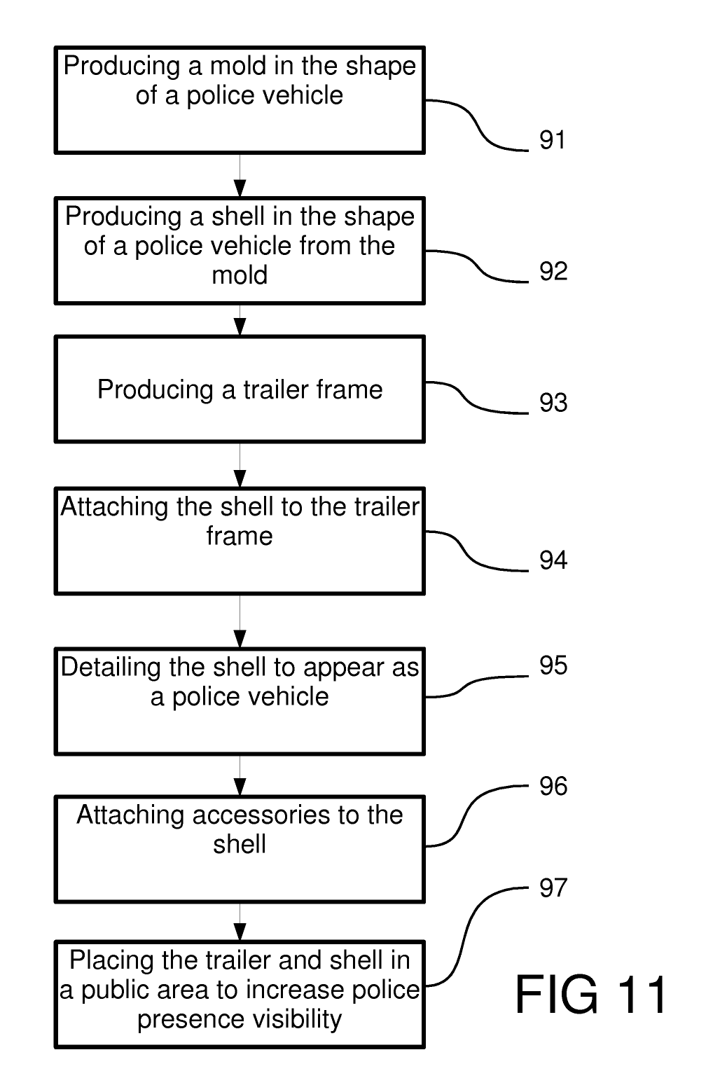

In an example method of making an imitation police passenger vehicle shown in FIG. 11, the first step may be producing a mold in the shape of a police passenger vehicle 91. The mold may be produced in many different ways, for example a mold of an actual vehicle may be made, which may be in several parts which are assembled to create a mold of the outer body of a passenger vehicle. In another example a mold may be produced by sculpting a vehicle which may be similar to a vehicle used by police, and then using the sculpting to create a mold. The mold may be created with the window areas as solid window areas, or the mold may be created with space so that glass or plastics may be inserted to simulate a vehicle window.

A next step may be producing a shell 92 which may be in the shape of a police passenger vehicle, and may be produced using the mold. The shell may be produced in one piece from fiberglass, or metal, or from resins, or from plastics or other material. The shell may also be produced in more than one piece and may be assembled to produce the outer skin of an imitation vehicle body.

The shell may be a structure with a top, a front, a back, and sides and with an open area on the bottom. The shell may also have a closed area on the bottom. The shell may include areas where it may be attached or secured to another object.

The next step may be to produce a trailer frame 93. The trailer frame may have a tongue, and may have four wheels. The four wheels may correspond to the position of wheels on a police passenger vehicle. The four wheels may include two wheels as a front set of wheels and two wheels as a back set of wheels. At least two of the wheels may be functional as part of the trailer.

The next step may be attaching the shell to the trailer frame 94. This may be done by using parts of the shell which have been prepared to attach to the trailer frame.

The next step may be detailing the shell to appear as a police passenger vehicle. As the mold may be produced in the shape of a police passenger vehicle body with the shape of headlights, side mirrors, door handles, and an emergency light strip, these areas of the shell may be painted, or have images printed on material applied to the areas of the shell with adhesive to make the areas of the shell to appear as real parts. The mold may also be produced without the shape of headlights, and without the shape of side mirrors, and without the shape of door handles, and without the shape of an emergency light strip. When the mold is produced without some or all of these items, the step of detailing the shell to appear as a police passenger vehicle 95 may include attaching the headlights, and the side mirrors, and the door handles and the emergency light strip to the molded shell, as well as other parts including but not limited to tail lights, and side marker lights.

The step of detailing the shell to appear as a police passenger vehicle 95 may also include placing an image on the shell on areas which correspond to the windows of a police passenger vehicle, where the image creates the appearance of a police office inside the shell, and further enhances the effect of a manned police passenger vehicle.

Another step in the process of producing an imitation vehicle which appears as a police passenger vehicle may include the step of attaching accessories to the shell 96. Accessories may include but are not limited to: antennas, a security camera dome, a search light, as well as other accessories which are commonly attached to police passenger vehicles.

A method of increasing police presence visibility may include the steps discussed above and shown in FIG. 11 for producing an imitation police passenger vehicle, and may also include placing the trailer and shell in a public area to increase police presence visibility 97. For example an imitation police passenger vehicle may be produced and placed at or near a school to increase the visibility of police presence in the area, and to deter crime and speeding or other dangerous activities in the area which may injure students or staff. If the imitation police passenger vehicle is used regularly in near or at the school students and others may become familiar with the vehicle and know that it is an imitation police passenger vehicle. To further deter illegal or unsafe activities a camera dome may be placed on the outside of the vehicle to give the presence of a security camera. A real security camera may be used in the camera dome and may wirelessly transmit a signal for increased security.

In another example use of an imitation police passenger vehicle, retail stores may place an imitation police passenger vehicle near the entrance of a store to give the impression of a police officer and a police passenger vehicle near the store. This may deter people from stealing from the store, and may deter attempts at violent crime such as armed robbery.

In another example of placing an imitation police passenger vehicle in an area where increased police visibility is desired, a residential neighborhood association may use an imitation police passenger vehicle to deter speeding in residential areas, and to increase the appearance of a police presence in the neighborhood. An imitation police passenger vehicle may also be used to enhance security in a gated community, or at an office building where security guards are present at times, and where the appearance of a police passenger vehicle may enhance the security and safety provided by the security guards.

In another example of placing an imitation police passenger vehicle in an area where increased police visibility is desired, a police department may place an imitation police passenger vehicle near a roadway to give the appearance of a police officer monitoring the roadway for motorists who are exceeding the speed limit. This may have the effect of slowing traffic to a safer speed and may reduce accidents and injuries.

In another example of placing an imitation police passenger vehicle in an area where increased police visibility is desired, a police department may place one or more imitation police passenger vehicles in an area where crime is often reported, or where crime has been reported in the past to discourage repeat offences of crime in the area.

While specific embodiments have been described in detail in the forgoing detailed description, and illustrated in the accompanying drawings, those with ordinary skill in the art will appreciate that various modifications and alternatives to those details could be developed in light of the overall teachings of the disclosure. Accordingly the particular arrangements disclosed are meant to be illustrative only and not limiting as to the scope of the invention which is to be given the full breadth of the appended claims, and any and all equivalents thereof.

I claim:

1. An imitation police passenger vehicle comprising:
a trailer frame having a trailer tongue, a first set of wheels attached to the trailer frame in a first location, and a second set of wheels attached to the trailer frame at a second location;
a molded shell being formed from moldable material in the shape of a police passenger vehicle body, the molded shell having a front, a rear, a top, and sides with wheel wells, the front of the molded shell having a windshield area which is formed of the moldable material in the shape of a windshield, the windshield area being formed as part of the molded shell, the molded shell having side window areas which are formed of the moldable material in the shape of side windows being formed as part of the molded shell, the molded shell having a rear window area which is formed of the moldable material in the shape of a rear window, the rear window area being formed as part of the molded shell;
the molded shell being mounted on the trailer frame so that the location of the first set of wheels and the second set of wheels corresponds with the wheel wells;
the molded shell being colored and detailed to appear like the police passenger vehicle body, at least one of: the windshield area; the side window areas; and the rear window area, having an image to appear like the window of the police passenger vehicle would appear to an observer when occupied; and
a emergency vehicle light being mounted on the top of the molded shell.

2. An imitation police passenger vehicle according to claim 1 further comprising:
a power supply; and
an electrical connection between the emergency vehicle light and the power supply so that the emergency vehicle light is operational.

3. An imitation police passenger vehicle according to claim 2 wherein the power supply is a battery which is charged by a solar panel, and wherein the solar panel is mounted on the molded shell.

4. An imitation police passenger vehicle according to claim 1 further comprising:
a security camera dome which is mounted on the molded shell.

5. An imitation police passenger vehicle according to claim 1 wherein the trailer tongue is removable to hide the trailer tongue from the view of an observer.

6. An imitation police passenger vehicle according to claim 1 wherein at least one of the first set of wheels and the second set of wheels is an operational set of wheels.

7. A method of making an imitation vehicle which appears like a police passenger vehicle comprising the steps of:
producing a mold in the shape of a body of a police passenger vehicle including the windows of the vehicle;
producing a shell in the shape of the police passenger vehicle body using the mold in the shape of the police passenger vehicle body, where the shell in the shape of the police passenger vehicle body includes solid areas corresponding to windows on the police passenger vehicle;
producing a trailer having a frame with four wheels, where at least two of the wheels are functional wheels, and where two of the four wheels are a front set of wheels approximately in the position of the front wheels of the police passenger vehicle, and where two of the four wheels are a back set of wheels approximately in the position of the back wheels of the police passenger vehicle;
attaching the shell in the shape of the police passenger vehicle body to the trailer so that the wheels on the trailer appear in a similar position as they appear on the police passenger vehicle and;
detailing the shell to appear as the police passenger vehicle.

8. A method of making an imitation vehicle which appears like a police passenger vehicle according to claim 7, further comprising the step of attaching an emergency light strip to the shell.

9. A method of making an imitation vehicle which appears like a police passenger vehicle according to claim 7, wherein the step of producing a mold in the shape of the police passenger vehicle body including the windows of the vehicle further includes producing the mold including the shape of headlights, side mirrors, door handles, and an emergency light strip.

10. A method of making an imitation vehicle which appears like a police passenger vehicle according to claim 7, wherein the step of producing a mold in the shape of the police passenger vehicle body including the windows of the vehicle further includes producing the mold without the shape of headlights, without the shape of side mirrors, without the shape of door handles and without the shape of an emergency light strip; the method further comprising the steps of:
attaching headlights to the molded shell;
attaching side mirrors to the molded shell;
attaching door handles to the molded shell; and
attaching an emergency light strip to the molded shell.

11. The method according to claim 7 where the step of detailing the shell to appear as the police passenger vehicle includes placing an image on the shell on the solid areas corresponding to the windows on the police passenger vehicle, where the image creates the appearance of a police officer inside of the shell.

12. A method of increasing police presence visibility including the steps of:
producing a mold substantially in the shape of a body of a police passenger vehicle;
producing a shell in the shape of the police passenger vehicle body using the mold in the shape of the police passenger vehicle body;
producing a trailer having a frame with four wheels, where at least two of the wheels are functional wheels, and where a front set of wheels are approximately in a first position corresponding to a position of front wheels of the police passenger vehicle, and where a back set of wheels are approximately in a second position corresponding to a position of back wheels of the police passenger vehicle;
attaching the shell in the shape of the police passenger vehicle body to the trailer so that the front set of wheels on the trailer appear in a similar position as the position of front wheels of the police passenger vehicle appear on the police passenger vehicle, and the back set of wheels appear in a similar position as the position of back wheels of the police passenger vehicle appear on the police passenger vehicle;
detailing the shell to appear as the police passenger vehicle;
placing the trailer with the shell in an area where increased police visibility is desired.

13. A method of increasing police presence visibility according to claim 12 where the shell in the shape of the police passenger vehicle body includes solid areas corresponding to windows on the police passenger vehicle; and
where the step of detailing the shell to appear as the police passenger vehicle includes placing an image on the shell on at least one of the solid areas corresponding to the windows on the police passenger vehicle, where the image creates the appearance of a police officer inside of the shell.

14. A method of increasing police presence visibility according to claim 12 where the step of detailing the shell to appear as the police passenger vehicle includes placing an emergency vehicle light on the shell.
